(19) United States
(12) Patent Application Publication
(10) Pub. No.: US 2005/0114887 A1
(43) Pub. Date: May 26, 2005

(54) Quality of video

(76) Inventor: Johan Hendrik Antoon Gelissen, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/506,377

(22) PCT Filed: Feb. 12, 2003
(86) PCT No.: PCT/IB03/00482

(30) Foreign Application Priority Data
Mar. 8, 2002 (EP) 02075935.3

(51) Int. Cl. H04N 7/00; H04N 7/084; H04N 7/08; H04N 11/00; G06F 13/00; H04N 5/445; G06F 3/00; H04N 5/14; H04N 7/087

(52) U.S. Cl. 725/47; 348/473; 348/461; 348/576

(57) ABSTRACT

The present invention is directed towards methods, devices and a signal format for providing information for achieving better perceived image quality of a transmitted video data stream. A video and information transmitting unit (28) in a device (20) transmits a video data stream and information about subjective quality relating to the video data stream in a signal comprising at least one frame with a header section, a motion vector section and a compressed image section. A device for processing a video data stream (32) includes a video and information receiving unit (34) which receives the signal, a decoding unit (38), which decodes the video data stream, and a control unit (36), which controls use of the information about subjective quality when processing the video data stream in order to achieve better perceived image quality.

### TECHNICAL FIELD

The present invention relates to achieving better perceived image quality of a transmitted video data stream.

### BACKGROUND OF THE INVENTION

Video data streams, normally provided in the form of compressed images and motion vectors could possibly be decoded in different ways. When streamed video is presented though, non-program content characteristics, such as frame rate, resolution and quantisation depth have different importance depending on the perceived subjective quality. However this is not taken into account in the video decoders of today.

It is known to provide complexity parameters in graphical 3-D applications. This information can be used to reduce the quality of the decoding if the complexity is high. This is done in order for a decoder to be able to produce a 3-D picture within an available time when the picture is complex.

U.S. Pat. No. 5,027,206 describes a film mode signaling bit included in a bit stream. Such an inclusion does however not indicate anything else than that it is a film and not information about subjective quality of the film, for instance what type of film it is. The result is that this cannot be used for optimal decoding, since films can be so called action movies with a lot of motion as well as dramas or wildlife movies, with less motion.

### SUMMARY OF THE INVENTION

It is an object of the present invention to provide better perceived image quality of a transmitted video stream in relation to limited decoding capabilities of a decoder and/or a post processor. To this end the invention provides methods, devices, a signal format and a storage medium as defined in the independent claims. Advantageous embodiments are defined in the dependent claims.

For different elements in video streams like frames, groups of frames or scenes there are different requirements of non-program content characteristics on the environment in which the video content is presented. For instance the color is more important in video streams showing wildlife content, whereas the information regarding motion of objects are more important if the video stream is an action film. Today these different aspects are not taken into account when processing a video stream, which leads to the video decoders and post processors of today not being used optimally. There is also a limited processing capability in the video decoders of today, which means that a compromise has to be made with respect to the different non-program content characteristics when decoding a video data stream to be presented to an end user.

The present invention achieves the object by providing better knowledge of the different contexts in which objects are shown in a video data stream for better use of the different decoding capabilities in a video decoder.

According to one aspect of the invention, this is achieved by a method of providing information for achieving better perceived image quality of a transmitted video data stream, including the steps of: transmitting a coded video data stream to a receiving device and transmitting information about subjective quality relating to the video data stream to the receiving device in order for the receiving device to be able to use said information when processing the video data stream.

According to this aspect, the problem is also solved by a device for providing information for achieving better perceived image quality of a transmitted video data stream, comprising: a video transmitting unit for transmitting a video data stream to a receiving device, and an information transmitting unit for transmitting information about subjective quality relating to the video data stream to the receiving device, in order for the receiving device to be able to use the information about subjective quality when processing the video data stream.

According to another aspect of this invention, this problem is also solved by a method of processing a video data stream comprising the steps of: receiving a video data stream, receiving information about subjective quality relating to the video data stream, and using the information about subjective quality when processing the video data stream in order to achieve better perceived image quality.

According to this aspect the problem is also solved by a device for processing a video data stream comprising: a video receiving unit for receiving a video data stream, an information receiving unit for receiving information about subjective quality relating to the video data stream, a decoding unit for decoding the video data stream, and a control unit for controlling use of the information about subjective quality when processing the video data stream in order to achieve better perceived image quality.

According to yet a further aspect of the present invention this problem is furthermore solved by a signal format for use in transmitting a video data stream comprising at least one frame with: a header section, a motion vector section and a compressed image section, wherein at least one of the sections include information about subjective quality relating to the video data stream for enabling a receiving device to use the information about subjective quality when processing the video data stream.

Preferred variations of the first mentioned aspects provide further advantages by providing the information about subjective quality in the video data stream.

According to yet a preferred variation of the different aspect of the invention, the information about subjective quality enables prioritization of non-content program characteristics in a decoder.

According to one variation of the present invention, the information about subjective quality also enables better use of a post processor.

With the expression subjective quality is meant such things as an action film or scene or a frame or group of frames of such a scene. It is thus related to such things like how much motion, color or perhaps detail there is in a video sequence or a whole video data stream. With program content is meant the objects, like things or persons actually shown in a video data stream. Subjective quality is thus related to the context in which objects in a video data stream are provided.

The term comprising is in no way to be interpreted limiting, but is to be understood to be equivalent to the term including.

PCT-application EP01/11565 filed Apr. 10, 2001 discloses quality tags that are added to a bit stream. These tags indicate the quality of an image related to the position in a bit stream. One quality measure mentioned is distortion. This is quite different than the subjective quality according to the present invention.

The basic idea of the present invention is thus to provide information about subjective quality, which provides a decoder with the necessary tools needed for prioritizing between different non-program content characteristics when decoding.

Additional benefits of the invention will be evident from the following description.

### BRIEF DESCRIPTION OF THE DRAWINGS

The invention will now be described in more detail with reference made to the enclosed drawings, where:

FIG. 1 shows a video data stream including subjective quality of video parameters signaling according to an embodiment of the invention.

FIG. 2 shows a block schematic of an apparatus for sending information about subjective quality of video to a receiving unit and said receiving unit for receiving subjective quality of video information.

FIG. 3 shows a flow chart of a method of sending subjective quality of video parameters.

FIG. 4 shows a flow chart of a method of receiving subjective quality of video parameter.

### DETAILED DESCRIPTION OF THE INVENTION

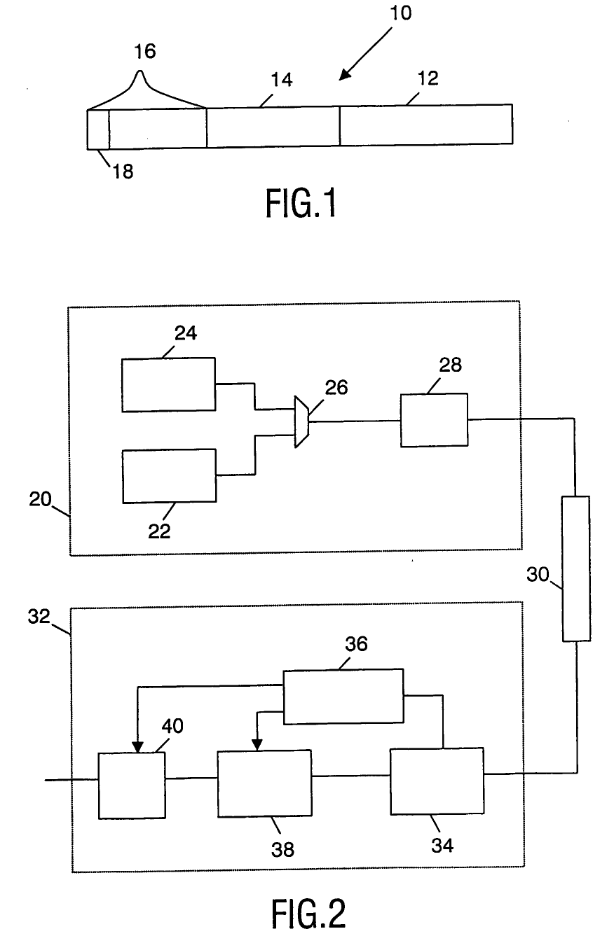

In FIG. 1 is shown a video signal 10 according to the present invention. The video signal can be a video signal according to any known standard such as MPEG-2, MPEG-4 or even more applicable an MPEG-21 signal. The video signal 10 includes a frame of video data comprising a compressed image section 12, a motion vectors section 14 and a header section 16. In the header section 16 there is included subjective quality of video parameters 18 according to the invention. This information can be put into each frame, into one frame of a group of frames or at the beginning of a scene including a number of group of frames. The information is also to be seen as an indication of type of program content, like for instance if a certain scene is having much motion or is slow in nature. The amount of information put into such a stream is actually dependent on the amount of work wanted to be put in by a video stream producer. FIG. 1 only shows a first frame of a video data stream. The stream normally includes a number of frames, grouped into groups of frames, where subjective quality of video parameters are valid until they are renewed at a frame, group of frame or scene level.

FIG. 2 shows a block schematic of a video coder or a device 20 for providing information for achieving better perceived image quality, which video coder is connected to a device 32 for processing a video data stream or a receiving device via a physical channel 30. The physical channel 30 can be any type of channel like for instance copper wire, optical or wireless. The video coder 20 includes a source encoder 22, which source encoder codes a video data stream. The coder 20 also includes a subjective parameter memory 24. Both the source encoder 22 and the subjective parameter memory 24 are connected to a multiplexer 26, which multiplexes subjective parameters 18 into the header of a frame in a source coded compressed video data stream. The multiplexer 26 is connected to a video and information transmitting unit or sender 28, which might include formatting or potential channel coding. The sender 28 is in turn connected to the physical channel 30. The physical channel is connected to a video and information receiving unit or subjective parameter extractor 34 of the receiving device 32. The subjective parameter extractor 34 is connected to a decoding unit or source decoder 38. A control unit 36 is connected to the parameter extractor 34 and to the source encoder 38. Finally a post processor 40 is connected to the source decoder 38. The control unit 36 is also connected to the post processor 40.

Now a preferred embodiment of the present invention will be described in relation to FIGS. 1 and 2. A first frame of a first group of frames of a video data stream is generated in the source encoder 22. This stream does not yet have subjective quality of video parameters. For this first frame the subjective parameter memory 24 submits two values, one first for indicating what type of movement will be present in the next group of frames and one second for indicating what the importance of color will be in the next group of frames. These two values are set so that they have different importance, i.e. one value can be more important than the other value. Once the parameters have been inserted into the frame, the frame will be transferred to sender 28 for sending as signal 10 to the receiving device 32 via the physical channel 30. The parameters indicate a subjective quality of the next number of frames of the video data stream. New parameters are thereafter inserted for the next group of frames etc. This continues for the whole video data stream.

The receiving device 32 receives the frame in the form of signal 10. When the receiving device 32 receives the frame it first demultiplexes and extracts the parameters from the video data stream in the subjective parameter extractor 34. The extracted parameters are forwarded to control unit 36, while the rest of the video data stream is forwarded to source decoder 38. The control unit 36 generates a first and second control signal in dependence of the received first and second parameters and makes the source decoder to set non-program content characteristics according to these control signals when decoding the video data stream. The first control signal, which has been set in dependence on the first parameter, sets the frame rate to be used when decoding, while the second parameter sets the color depth. These parameters are examples of preferred parameters at this point in time. It is possible to use more clever and complex parameters instead. The control unit 36 also uses a prioritization scheme between the two parameters, in that one is more important than the other. This also means that if the first parameter has indicated that the program includes a big amount of movement and the second parameter has indicated a lower importance of color, the control unit controls the source decoder 38 to have a high frame rate while using fewer bits than what is normally used for resolution. After decoding the first frame of the video data stream, the source decoder 38 forwards the decoded video data to post processor 40, which does some post-processing of the decoded video data stream. Here the control unit 36 influences settings or performance in the post processor 40 based on the received parameters in order to achieve optimal perceived image quality. In the preferred embodiment the motion compensation is influenced. However, it is also possible to influence such things as noise reduction, frame/field up-conversion and the like. The decoder continues decoding the following frames in the first group of frames using the same prioritization scheme until a next first frame of a following group of frames is received, and then the above described extraction and prioritization is repeated. This continues in the way described above until the whole data stream has been decoded.

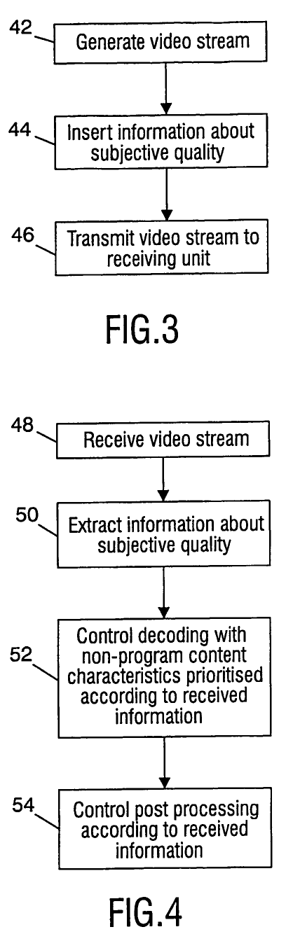

Now a method of providing information for achieving better image quality according to the present invention will be described with reference to FIG. 3, which shows a flow chart of the method according to the invention. First a video data stream is generated, step 42. Thereafter information about subjective quality concerning the data stream, in the form of a first and a second parameter, is inserted in the stream, step 44. After this step the video data stream is transmitted to the receiving unit, step 46, so that prioritization of non-program content characteristics can take place, when decoding the stream. The above-mentioned steps are then repeated for the first frame of all following groups of frames of the video data stream.

Now a method of processing a video data stream will be described with reference to FIG. 5, which shows a flow chart of said method. First a video data stream is received, step 48. Thereafter information about subjective quality in the form of the first and second parameter is extracted from a first frame of a first group of frames in the stream, step 50. After this the decoding of the rest of the data in the first group of frames is being performed, where the non program-content characteristics of the decoding have been prioritized according to the received information, step 52. This means that non-program content characteristics receive different attention because of the prioritization. The quantisation depth and resolution could for instance be lowered in overload situations while the frame rate could be kept up to the desired level as a result. This also means that the subjective quality information is used when decoding the video data stream. Thereafter the post processing is also controlled according to the received information about subjective quality, step 54. The above-mentioned steps are thereafter repeated for each group of frames.

With the described preferred embodiment of the invention there has been described a way to better decode a video data stream in an environment of limited resources. According to the present invention information about subjective quality of video is transferred to a decoder, which uses this subjective information in prioritizing non-program content characteristics when decoding. Such characteristics are for instance frame rate, resolution and quantisation depth, which can be prioritized so that the video data stream is decoded with different levels of refinery for these characteristics. One characteristic then gets higher attention than another characteristic for a frame, group of frames or scene. In this way frames having a lot of motion information can for instance be indicated as such, so that the non-program characteristics important for motion like frame rate can get a higher priority, while frames having lower content of motion can get a prioritization of resolution and quantisation depth so that for instance colors get a higher resolution. With the preferred embodiment of the present invention different parts of a video data stream can have the parameters set differently, which makes it possible to decode the video data stream with a good perceived quality for the viewer, even when the different type of scenes are shown in the same stream.

The invention can be varied in many ways. First of all there was described providing two parameters. The invention is not limited to two parameters, but one or more than two can be provided. There does also not need to be a 1:1 correspondence between a parameter and a non-content characteristic. A parameter can for instance be used to determine the priority of all or some of the non-content characteristics. Furthermore, frame rate, resolution and quantisation depth are just a few of the possible non-program content characteristics, which can be prioritized according to the invention. There are thus a number of parameters that can control the performance of scalable decoders.

According to the present invention control of some characteristics in the post-processing based on the subjective quality of video parameters is also performed. This was described as being done in addition to control of the decoding. This control could however also be done instead of the control of non-program content characteristics of the video decoder. Another variation of the present invention is that subjective quality of video parameters do not have to be provided once for each group of frames or in the first frame of a group of frames. They can equally as well be provided in any of the frames of a group of frames, in each frame, each scene or just once for the whole video data stream. In case they are just provided once for the whole stream, the prioritization is done once for the whole video data stream. In this case there is no adjustment for different scenes, frames or group of frames of the video data stream, but the same prioritization applies for the whole video data stream. In this special case, the information does also not have to be provided in the actual video data stream but can be received from for example an electronic program guide. It is furthermore possible to provide the subjective quality of video parameters in a separate information stream or separate information signal, even if a scene, frame or group of frames is to be controlled using this information. However if decoding control is to be varied during decoding, the video data stream has to be synchronized with the signal comprising subjective quality of video parameters. In this case the video data stream and the information stream can be received simultaneously. As an alternative the subjective quality of video parameters can be received or downloaded beforehand and not necessarily from the same source as the video data stream. The control unit then needs to synchronize between both information sources in order to apply different decoding of the video stream according to the downloaded or received (through a secondary stream) parameters.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word ‘comprising’ does not exclude the presence of other elements or steps than those listed in a claim. The invention can be implemented by means of hardware comprising several distinct elements, and by means of a suitably programmed computer. In a device claim enumerating several means, several of these means can be embodied by one and the same item of hardware. The mere fact that certain measures are recited in mutually different dependent claims does not indicate that a combination of these measures cannot be used to advantage.

1. Method of providing information for achieving better perceived image quality of a transmitted video data stream, including the steps of:
transmitting a coded video data stream to a receiving device, and
transmitting information about subjective quality relating to the video data stream to the receiving device in order for the receiving device to be able to use said information when processing the video data stream.

2. Method according to claim 1, further comprising the step of inserting the information about subjective quality in the data stream for indicating the importance of processing non-program content characteristics in view of content quality, so that the information about subjective quality can be extracted from the video data stream.

3. Method according to claim 1, wherein the information about subjective quality includes program information from an electronic program guide.

4. Method according to claim 1, wherein the information about subjective quality includes information about content type per frame, per group of frames or per scene.

5. Method according to claim 1, wherein the information about subjective quality includes information enabling prioritization of non-content program characteristics in the receiving device.

6. Method of processing a video data stream comprising the steps of:
receiving a video data stream,
receiving information about subjective quality relating to the video data stream, and
using the information about subjective quality when processing the video data stream in order to achieve better perceived image quality.

7. Method according to claim 6, wherein the step of using includes using the information about subjective quality for control of non-program content characteristics when decoding the video data stream.

8. Method according to claim 6, wherein the step of using includes using the information about subjective quality for post processing of the video data stream after decoding.

9. Method according to claim 6, wherein the information about subjective quality is included in the video data stream for indicating the importance of processing on non-program content characteristics in view of content quality and further including the step of extracting the information about subjective quality from the coded video data stream.

10. Method according to claim 6, wherein the information about subjective quality includes program information from an electronic program guide.

11. Method according to claim 9, wherein the information about subjective quality includes information of content type per frame, per group of frames or per scene.

12. Method according to claim 7, wherein the non-program content characteristics are any of the characteristics frame rate, resolution, color depth or motion estimation.

13. Method according to claim 7, wherein the step of using includes prioritizing the different non-program content characteristics based on the information on subjective quality and controlling the decoding of the video data stream according to the prioritization made.

14. A device for providing information for achieving better perceived image quality of a transmitted video data stream, comprising:
a video transmitting unit for transmitting a video data stream to a receiving device, and
an information transmitting unit for transmitting information about subjective quality relating to the video data stream to the receiving device, in order for the receiving device to be able to use the information about subjective quality when processing the video data stream.

15. Device according to claim 14, wherein the video transmitting unit and the information transmitting unit are incorporated in the same transmitting unit, so that the information about subjective quality is included in the video data stream for indicating the importance of processing on given non-program content characteristics in view of content quality.

16. Device according to claim 14, wherein the information about subjective quality includes information enabling prioritization of non-content program characteristics in the receiving device.

17. Device for processing a video data stream comprising:
a video receiving unit for receiving a video data stream,
an information receiving unit for receiving information about subjective quality relating to the video data stream,
a decoding unit for decoding the video data stream, and
a control unit for controlling use of the information about subjective quality when processing the video data stream in order to achieve better perceived image quality.

18. Device according to claim 17, wherein the control unit is arranged to use the information about subjective quality for control of non-program content characteristics when decoding the video data stream.

19. Device according to claim 17, wherein information about subjective quality is included in the video data stream, the video and information receiving units are incorporated in the same receiving unit and the control unit is arranged to extract the information about subjective quality relating to the video data stream from the video data stream.

20. Device according to claim 17, wherein the control unit is further arranged to prioritize the different non-program content characteristics based on the information on subjective quality and to control the decoding of the video data stream according to the prioritization made.

21. Device according to claim 17, further including a post processor for post processing of the decoded video data stream, wherein the control unit is arranged to use the information about subjective quality for control of the post processor.

22. A signal format for use in transmitting a video data stream comprising at least one frame with:
a header section,
a motion vector section and
a compressed image section,
wherein at least one of the sections include information about subjective quality relating to the video data stream for enabling a receiving device to use the information about subjective quality when processing the video data stream.

23. Signal format according to claim 21, wherein the information about subjective quality includes information enabling prioritization of non-content program characteristics in the receiving device.

24. (currently amended) A storage medium on which a signal format as claimed in claim 22 has been stored.
